(19) United States
(12) Patent Application Publication
(10) Pub. No.: US 2015/0114922 A1
(43) Pub. Date: Apr. 30, 2015

(54) Disposable Baby Bottle

(71) Applicants: Angela Kohn, Oswego, IL (US); Stephen Kohn, Oswego, IL (US)

(72) Inventors: Angela Kohn, Oswego, IL (US); Stephen Kohn, Oswego, IL (US)

(21) Appl. No.: 14/067,151

(22) Filed: Oct. 30, 2013

(51) Int. Cl. A61J 9/00; B67C 3/22

(52) U.S. Cl. CPC A61J 9/008; B67C 3/22
USPC 215/11.1; 53/471

(57) ABSTRACT

The invention is directed toward a disposable baby bottle. The baby bottle is pre-filled with nursery water and comprises a bottle body, a cap, a bottle bottom, and a nipple. The bottle body has a pair of shaped ergonomic recesses. The bottle body has an upper opening and a lower opening with a safety seal and an external threading surrounding the lower opening of the bottle body. The bottle body has a nipple ring circumscribing the upper opening of the bottle body. The cap has one or more break away tabs. The cap has a flat base distal from the breakaway tabs permitting the bottle body to be inverted and stood when the cap is secured to the bottle body. The bottle bottom has an internal threading complementary to the external threading of the bottle body. The nipple is affixed to the inner portion of the nipple ring.

### TECHNICAL FIELD

The invention relates generally to baby bottles and more specifically to a disposable baby bottle pre-filled with distilled nursery water having a flange cap for vertically standing up the bottle during the filling process, a wide twist off bottle bottom, an ergonomically shaped bottle body having a nipple ring, and a nipple affixed to the inner surface of the nipple ring with an adhesive.

### BACKGROUND OF THE INVENTION

Baby bottles are known in the prior art. Baby bottles provide an easy and convenient means of providing formula to an infant. Parents can mix formula in a large amount at one time and fill a bottle at the time of feeding. Such a process is easy when a parent is located at home. A parent takes formula in powder form and mixes it with water in a predetermined ratio to make the formula for the baby to drink. Premixed formula is available to parents but may not always be desirable. Premixed formula is good for on the go parents who are away from home. However, premixed formula has its limitations. Some specific formulas are only available in powder form. Furthermore, premixed formula may not be available in the ratio desirable by the parent. Premixed formula that is not in the correct ratio may cause reflux or colic in the baby. In addition, bottles and nipples intended to be reused multiple times are required to be cleaned and/or sterilized after every use. What is needed is a disposable bottle pre-filled with nursery water by the manufacturer, which is designed for the mixture of powdered formula when a parent is out of the house or does not have any clean bottles. What is needed is a disposable baby bottle which requires no sterilization or cleaning, is a low-cost alternative to premixed formula, and is packaged in aseptic conditions.

### SUMMARY OF THE INVENTION

The invention is directed toward a disposable baby bottle. The disposable baby bottle comprises a bottle body, a cap, a bottle bottom, a nipple, a perforated plastic shrink band surrounding the cap, and a safety seal. The cap cannot be removed from the bottle body without first removing the plastic shrink band. The bottle body has a pair of shaped ergonomic recesses. The bottle body has an upper opening and a wide lower opening with external threading surrounding the lower opening of the bottle body. The bottle body has a nipple ring circumscribing the upper opening of the bottle body. The nipple ring is a continuous extension of the bottle body. The cap has one or more break away safety tabs to deter pilferage. The cap has a flat base distal from the break away safety tabs permitting the bottle body to be inverted and stood when the cap is secured to the bottle body. The bottle bottom has an internal threading complementary to the external threading of the bottle body. The safety seal is removably adhered to the entire circumference of the lower opening of the bottle body. The safety seal has a pull tab permitting the removal of the safety seal from the lower opening of the bottle body. The nipple is placed from the bottle bottom through the upper opening of the bottle body during the manufacturing process. The nipple is affixed to the inner surface of the upper opening of the bottle body with an adhesive to prevent reuse of the bottle. The bottle is pre-filled with nursery water during the manufacturing process.

In another embodiment the cap may have four breakaway safety tabs. Furthermore, the cap may have two internal secure ridges on alternating breakaway safety tabs. Furthermore, the cap may be secured to the bottle body by the internal secure ridges being placed beneath the lower edge of the nipple ring. The different parts of the invention may be manufactured from any type of standard consumer material such as plastic or glass. In the preferred embodiment, the bottle body is formed of a thermoplastic, the bottle bottom is formed of a thermoplastic, the cap is formed of a thermoplastic, and the nipple is formed of silicone. In another embodiment of the invention the shaped ergonomic recesses are circular. Furthermore, the cap may measure 2.18 inches long and 3.06 inches in maximum diameter, the bottle body may measure 6.13 inches long and 3.23 inches in diameter at the lower opening, and the bottle bottom may measure 0.74 inches long and 3.23 inches diameter at the upper edge of the bottle bottom.

In the bottle the formula is mixed and served to an infant by standing the pre-filled bottle body in an inverted position, the bottle being stood on the flat base of the cap, unscrewing the bottle bottom from the bottle body, removing the safety seal from the lower opening of the bottle bottom, filling the bottle body with a predetermined ratio of powdered formula, screwing the bottle bottom to the bottle body, removing a plastic shrink band from the break away tabs of the cap, removing one or more break away tabs, removing the cap from the bottle body, and presenting the bottle to the infant.

In one embodiment of the invention the baby bottle further comprises a measuring cup. The measuring cup is removably attached to the interior of the bottle bottom by two or more notches. The notches are located at the inner bottom of the bottle bottom. The measuring cup has a handle for removing the cup from the notches of the bottle bottom. The measuring cup has one or more scale markings displaying the volume of the measuring cup.

In one embodiment of the invention the disposable bottle has a volume sufficient to hold approximately six fluid ounces. This embodiment of the invention may further comprise a measuring cup. The measuring cup is removably attached to the interior of the bottle bottom by two or more notches. The notches are located at the inner bottom of the bottle bottom. The measuring cup has a handle for removing the cup from the notches of the bottle bottom. The measuring cup has one or more scale markings displaying the volume of the measuring cup.

In another embodiment of the invention the bottle has a volume sufficient to hold approximately twelve fluid ounces. This embodiment of the invention may further comprise a measuring cup. The measuring cup is removably attached to the interior of the bottle bottom by two or more notches. The notches are located at the inner bottom of the bottle bottom. The measuring cup has a handle for removing the cup from the notches of the bottle bottom. The measuring cup has one or more scale markings displaying the volume of the measuring cup.

The invention is also directed toward a method for filling a baby bottle with formula comprising standing the pre-filled bottle body in an inverted position, the bottle being stood on the flat base of the cap, unscrewing the bottle bottom from the bottle body, removing the safety seal from the lower opening of the bottle bottom, filling the bottle body with a predetermined ratio of powdered formula, screwing the bottle bottom to the bottle body, removing a plastic shrink band from the break away tabs of the cap, removing one or more break away tabs, removing the cap from the bottle body, and presenting the bottle to the infant.

The bottle used in the method is a disposable baby bottle comprising a bottle body, a cap, a bottle bottom, a nipple, a perforated plastic shrink band surrounding the cap, and a safety seal. The cap cannot be removed from the bottle body without first removing the plastic shrink band. The bottle body has a pair of shaped ergonomic recesses. The bottle body has an upper opening and a wide lower opening with external threading surrounding the lower opening of the bottle body. The bottle body has a nipple ring circumscribing the upper opening of the bottle body. The nipple ring is a continuous extension of the bottle body. The cap has one or more break away safety tabs to deter pilferage. The cap has a flat base distal from the break away safety tabs permitting the bottle body to be inverted and stood when the cap is secured to the bottle body. The bottle bottom has an internal threading complementary to the external threading of the bottle body. The safety seal is removably adhered to the entire circumference of the lower opening of the bottle body. The safety seal has a pull tab permitting the removal of the safety seal from the lower opening of the bottle body. The nipple is placed from the bottle bottom through the upper opening of the bottle body during the manufacturing process. The nipple is affixed to the inner surface of the upper opening of the bottle body with an adhesive to prevent reuse of the bottle. The bottle is pre-filled with nursery water during the manufacturing process.

In another embodiment of this process, the baby bottle further comprises a measuring cup. The measuring cup is removably attached to the interior of the bottle bottom by two or more notches. The notches are located at the inner bottom of the bottle bottom. The measuring cup has a handle for removing the cup from the notches of the bottle bottom. The measuring cup has one or more scale markings displaying the volume of the measuring cup.

### BRIEF DESCRIPTION OF THE DRAWINGS

FIG. 1 is an exploded view of the bottle.

FIG. 2 is a side view of the assembled bottle.

FIG. 3 is a side view of the assembled bottle.

FIG. 4 is a side view of the bottle body.

FIG. 5 is a side view of the bottle body.

FIG. 6 is a top view of the cap.

FIG. 7 is a top view of the bottle body.

FIG. 8 is a perspective view of the bottle bottom.

FIG. 9 is a perspective view of the cap.

FIG. 10 is a perspective view of the bottle body with safety seal.

FIG. 11 is a side view of the assembled bottle with perforated plastic shrink band surrounding the cap.

FIG. 12 is a perspective view of the measuring cup FIG. 13 is a perspective view of the measuring cup secured within the bottle bottom

### DETAILED DESCRIPTION OF THE DRAWINGS

Although the present invention will be described with reference to the exemplary embodiments shown in the drawings, it should be understood that the present invention can be embodied in many alternate forms or embodiments.

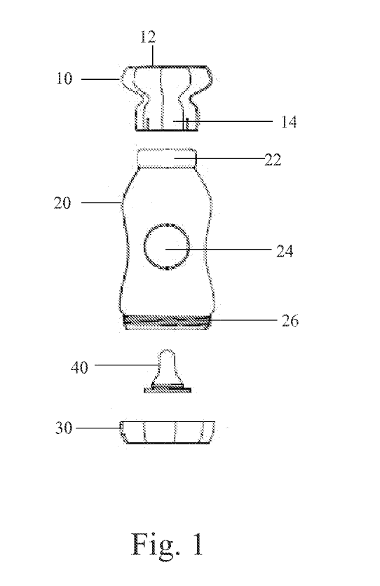

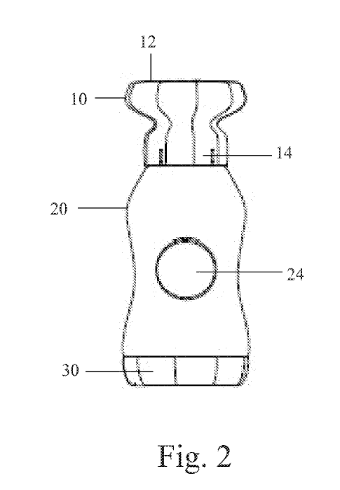

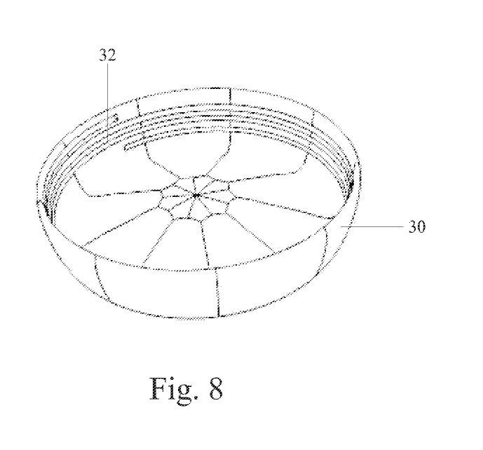

Referring to FIG. 1, the invention is directed toward a disposable baby bottle comprising a cap 10, a bottle body 20, a bottle bottom 30, and a nipple 40. The cap 10 is formed with a flat base 12 and breakaway security tabs 14. The bottle body 20 is formed with a nipple ring 22, a pair of shaped ergonomic recesses 24, and a lower bottle external threading 26. As shown in FIG. 8, the bottle bottom 30 has an internal threading 32.

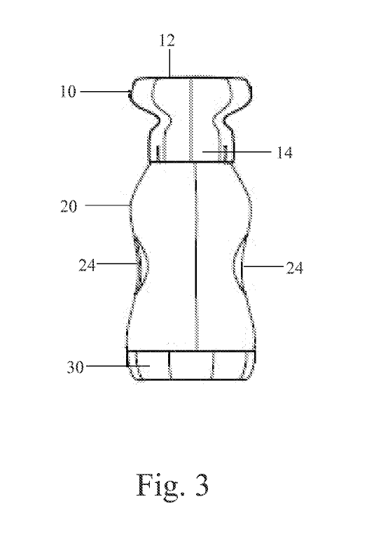

Referring to FIG. 2 and FIG. 3, when the baby bottle is assembled the cap 10 is removably attached to the bottle body 20. The breakaway security tabs 14 are secured onto the nipple ring 22. The bottle bottom 30 is secured onto the bottle body 20. The lower bottle external threading 26 is complementary to the internal threading 32 of the bottle bottom 30. The bottle bottom 30 screws onto the bottle body 20.

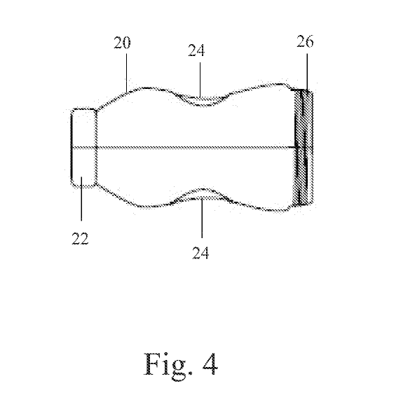

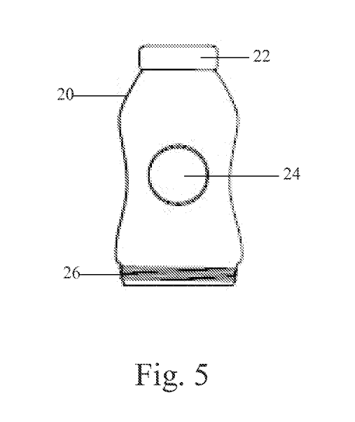

Referring to FIG. 4 and FIG. 5, the bottle body 20 has a pair of shaped ergonomic recesses 24. The shaped ergonomic recesses 24 are directly opposite of each other on the bottle body 20. This allows an infant to hold the bottle easily while drinking formula. The shaped ergonomic recesses 24 may be in any shape that allows for an infant to easily hold the bottle. In the preferred embodiment, the shaped ergonomic recesses 24 are circular. In addition, the bottle body 20 has a nipple ring 22 located at the top of the bottle body 20. The nipple ring 22 and bottle body 20 are one continuous item.

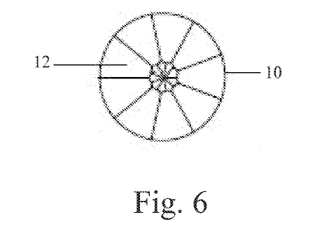

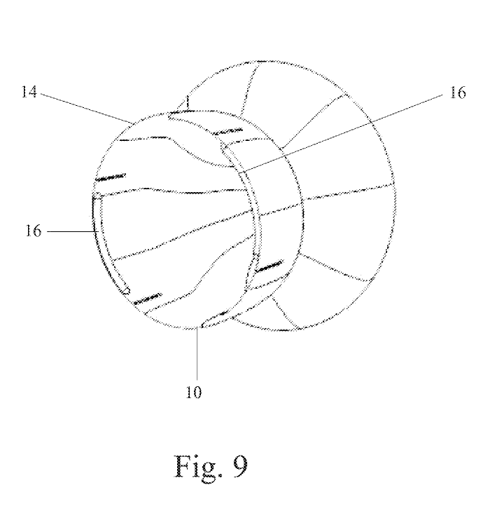

Referring to FIG. 6 and FIG. 9, the cap 10 has a broad and wide flange having a flat base 12. On the opposite end of the cap 10 are four break away tabs 14. Two of the break away tabs 14 have internal secure ridges 16. The internal secure ridges 16 are on two of the break away tabs 14. The internal secure ridges 16 are on opposite breakaway tabs 14. The internal secure ridges 14 are designed to secure the cap 10 to the bottle body 20 by securing under the lower external edge of the nipple ring 22. In another embodiment, each of the break away tabs 14 has an internal secure ridge 16.

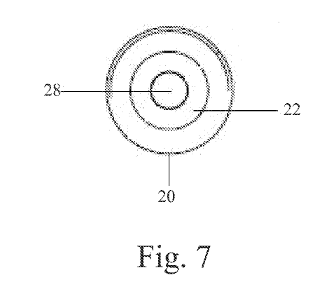

Referring to FIG. 7, when the bottle is assembled during the manufacturing process, the nipple 40 passes from the bottle bottom through the nipple opening 28 in the nipple ring 22. The lower edge of the nipple 40 is placed inside the bottle body 20. The lower edge of the nipple 40 pushes against the internal edge of the nipple ring 22 to create a watertight seal. This prevents the leakage of any formula when the infant is drinking. The lower edge of the nipple 40 is adhered to the internal edge of the nipple ring 22 by means of an adhesive.

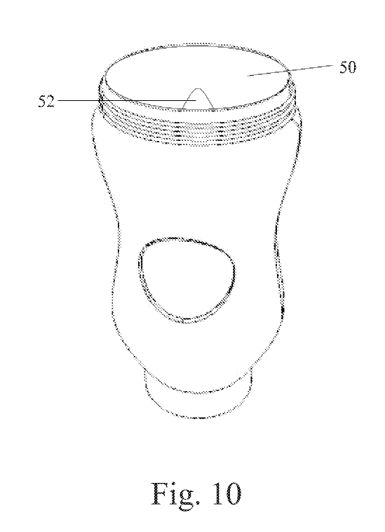

Referring to FIG. 10, the lower opening of the bottle body 20 is sealed with a safety seal 50. The safety seal 50 is removably adhered to the entire circumference of the lower opening of the bottle body 20. The safety seal 50 has a pull tab 52. By lifting the pull tab 52 a person can remove the safety seal 50. The safety seal 50 and pull tab 52 may be made of any flexible and sealable material such as a thermoplastic or metal foil. In the preferred embodiment, the safety seal 50 and pull tab 52 are formed from a plastic and metal foil combination.

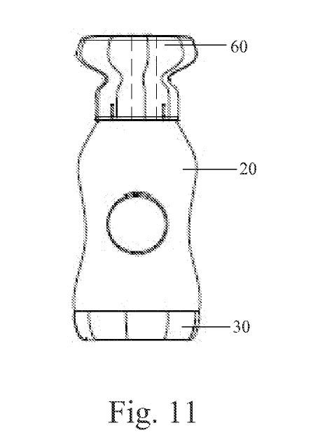

Referring to FIG. 11, the fully assembled bottle has a perforated plastic shrink band 60 which is sealed around the cap 10. The perforated plastic shrink band 60 has a series of vertical perforations allowing for easy removal of the perforated plastic shrink band 60. The cap 10 cannot be removed from the bottle body 20 without first removing the perforated plastic shrink band 60.

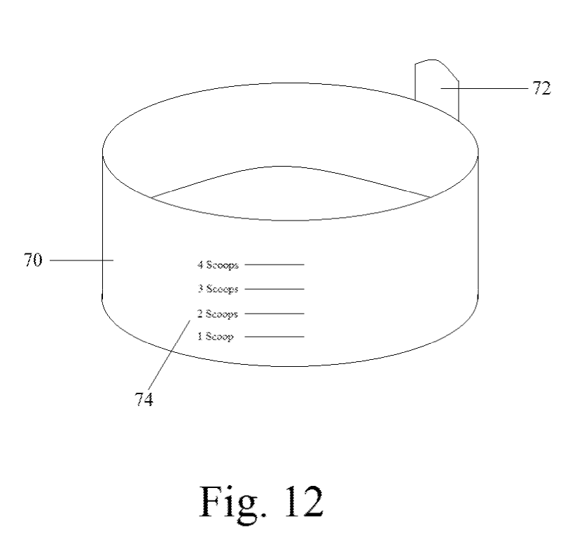

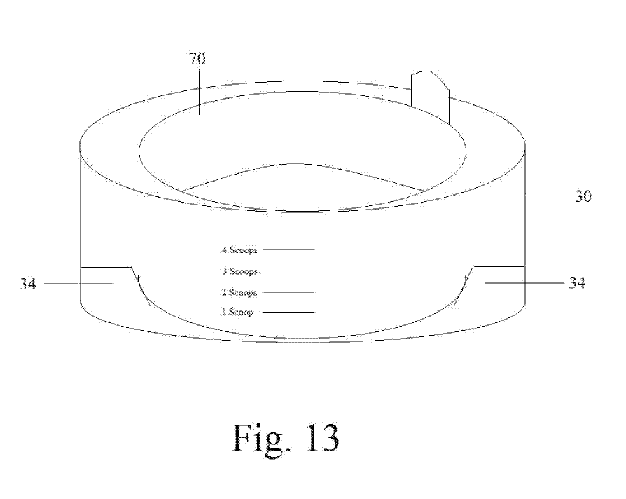

Referring to FIG. 12 and FIG. 13, the bottle bottom 30 includes a measuring cup 70. The measuring cup 70 is secured within the bottle bottom 30 by a pair of notches 34 within the internal portion of the bottle bottom 30. The notches 34 fit securely against the bottom edge of the measuring cup 70. When fit within the notches 34, the measuring cup 70 is removably secure such that if placed in an inverted position, the measuring cup 70 remains secure within the notches 34. The measuring cup 70 has a handle 72 which allows for the easy removal of the measuring cup 70 from the notches 34. The measuring cup 70 also has a series of scale markings 74. The scale markings 74 permit a parent to select a desirable amount of baby formula powder to add to the water already present in the bottle body 20. The scale markings 74 may be in any format for relaying the incremental volume of the measuring cup 70. In the preferred embodiment, the scale markings 74 display the number of scoops of powdered formula to add to the water. The measuring cup 70 may be formed of any standard thermoplastic. The measuring cup 70 is of a sufficient size such that the measuring cup 70 may fit securely within the bottle bottom 30 while the bottle bottom 30 is screwed onto the bottle body 20 without touching the safety seal 50.

The invention is directed to a disposable baby bottle for a one-time use when a parent is in public without a prepared baby bottle but has powdered formula. To use the bottle, the parent stands a pre-filled bottle in an inverted position on the cap 10 of the bottle, unscrews the bottle bottom 30 from the bottle body 20, removes the safety seal 50 from the lower opening of the bottle body 20, fills the bottle body 20 with a predetermined ratio of water and powdered formula, screws the bottle bottom 30 to the bottle body 20, removes a perforated plastic shrink band 60 from the break away tabs 14 of the cap 10, removes one or more break away tabs 14, removes the cap 10 from the bottle body 20, and presents the bottle to the infant.

1. A disposable baby bottle comprising
A bottle body
Said bottle body having a pair of shaped ergonomic recesses
Said bottle body having an upper opening and a lower opening external threading surrounding the lower opening of said bottle body
Said bottle body having a nipple ring circumscribing said upper opening of said bottle body
Wherein said nipple ring is a continuous extension of said bottle body
Said bottle is pre-filled with nursery water during manufacturing process
A cap
Said cap having one or more break away safety tabs
Said cap having a flat base distal from the break away safety tabs permitting said bottle body to be inverted and stood when said cap is on said bottle body
A perforated plastic shrink band surrounding said cap
Wherein said cap cannot be removed from said bottle body without first removing said plastic shrink band
A bottle bottom
Said bottle bottom having an internal threading complementary to said external threading of said bottle body
A safety seal
Said safety seal removably adhered to the entire circumference of said lower opening of said bottle body
Said safety seal having a pull tab permitting the removal of the safety seal from said lower opening of said bottle body
A nipple
Wherein said nipple is placed from the bottle bottom through said upper opening of said bottle body during manufacturing process
Wherein said nipple is affixed to the inner surface of said upper opening with an adhesive to prevent reuse of the bottle

2. The bottle as in claim 1
Wherein said cap has four breakaway safety tabs

3. The bottle as in claim 2
Wherein said cap has two internal secure ridges on alternating breakaway safety tabs

4. The bottle as in claim 3
Wherein said cap is secured to said bottle body by said internal secure ridges being placed beneath the lower edge of said nipple ring

5. The bottle as in claim 4
Wherein said bottle body is formed of a thermoplastic
Wherein said bottle bottom is formed of a thermoplastic
Wherein said cap is formed of a thermoplastic
Wherein said nipple is formed of silicon

6. The bottle as in claim 5
Wherein said shaped ergonomic recesses are circular

7. The bottle as in claim 6
Wherein said cap measures 2.18 inches long and 3.06 inches in maximum diameter
Wherein said bottle body measures 6.13 inches long and 3.23 inches in diameter at said lower opening
Wherein said bottle bottom measures 0.74 inches long and 3.23 inches diameter at the upper edge of said bottle bottom

8. The bottle as in claim 7
Wherein said formula is mixed and served to an infant by standing said pre-filled bottle body in an inverted position, said bottle being stood on said flat base of said cap, unscrewing said bottle bottom from said bottle body, removing said safety seal from said lower opening of said bottle bottom, filling said bottle body with a predetermined ratio of powdered formula, screwing said bottle bottom to said bottle body, removing a plastic shrink band from said break away tabs of said cap, removing one or more break away tabs, removing said cap from said bottle body, and presenting said bottle to said infant.

9. The bottle as in claim 8 further comprising
A measuring cup
Wherein said measuring cup is removably attached to the interior of said bottle bottom by two or more notches
Said notches being located at the inner bottom of said bottle bottom
Said measuring cup having a handle for removing said cup from said notches of said bottle bottom
Said measuring cup having one or more scale markings displaying the volume of said measuring cup

10. The bottle as in claim 6
Wherein said bottle has a volume sufficient to hold approximately six fluid ounces

11. The bottle as in claim 10 further comprising
A measuring cup
Wherein said measuring cup is removably attached to the interior of said bottle bottom by two or more notches
Said notches being located at the inner bottom of said bottle bottom
Said measuring cup having a handle for removing said cup from said notches of said bottle bottom
Said measuring cup having one or more scale markings displaying the volume of said measuring cup

12. The bottle as in claim 6
Wherein said bottle has a volume sufficient to hold approximately twelve fluid ounces

13. The bottle as in claim 12 further comprising
A measuring cup
Wherein said measuring cup is removably attached to the interior of said bottle bottom by two or more notches
Said notches being located at the inner bottom of said bottle bottom
Said measuring cup having a handle for removing said cup from said notches of said bottle bottom
Said measuring cup having one or more scale markings displaying the volume of said measuring cup

14. A method for filling a disposable baby bottle with formula comprising
Standing a bottle in an inverted position on the cap of said bottle
Said bottle comprising
A bottle body
Said bottle body having a pair of shaped ergonomic recesses
Said bottle body having an upper opening and a lower opening
external threading surrounding the lower opening of said bottle body
Said bottle body having a nipple ring circumscribing said upper opening of said bottle body
Wherein said nipple ring is a continuous extension of said bottle body
Said bottle is pre-filled with nursery water during manufacturing process
A cap
Said cap having one or more break away safety tabs
Said cap having a flat base distal from the break away safety tabs permitting said bottle body to be inverted and stood when said cap is on said bottle body
A perforated plastic shrink band surrounding said cap
Wherein said cap cannot be removed from said bottle body without first removing said plastic shrink band
A bottle bottom
Said bottle bottom having an internal threading complementary to said external threading of said bottle body
A safety seal
Said safety seal removably adhered to the entire circumference of said lower opening of said bottle body
Said safety seal having a pull tab permitting the removal of the safety seal from said lower opening of said bottle body
A nipple
Wherein said nipple is placed from the bottle bottom through said upper opening of said bottle body during manufacturing process
Wherein said nipple is affixed to the inner surface of said upper opening with an adhesive to prevent reuse of the bottle
unscrewing said bottle bottom from said bottle body
removing said safety seal from said lower opening of said bottle bottom
filling said bottle body with a predetermined ratio of water and powdered formula
screwing said bottle bottom to said bottle body
removing a plastic shrink band from said break away tabs of said cap
removing one or more break away tabs
removing said cap from said bottle body
and presenting said bottle to said infant

15. The method as in claim 14 wherein said baby bottle further comprises
A measuring cup
Wherein said measuring cup is removably attached to the interior of said bottle bottom by two or more notches
Said notches being located at the inner bottom of said bottle bottom
Said measuring cup having a handle for removing said cup from said notches of said bottle bottom
Said measuring cup having one or more scale markings displaying the volume of said measuring cup.
